(19) United States
(12) Patent Application Publication
(10) Pub. No.: US 2003/0039841 A1
(43) Pub. Date: Feb. 27, 2003

(54) Enhanced ceramic layers for laminated ceramic devices and method

(75) Inventors: Ross A. Miesem, Albuquerque, NM (US); Kristen June Law, Scottsdale, AZ (US); Jeremy W. Burdon, Scottsdale, AZ (US); Rickey G. Pastor, Schaumburg, IL (US)

Correspondence Address: MOTOROLA, INC., CORPORATE LAW DEPARTMENT - #56-238, 3102 NORTH 56TH STREET, PHOENIX, AZ, 85018, US

(73) Assignee: Motorola, Inc.

(21) Appl. No.: 09/940,290

(22) Filed: Aug. 27, 2001

(51) Int. Cl. B32B 15/00; B05D 3/02

(52) U.S. Cl. 428/432; 428/434; 427/376.2; 427/427; 427/420; 427/430.1

(57) ABSTRACT

An enhanced ceramic layer is produced for use in laminated ceramic devices. A layer of unfired ceramic material is provided and a coating of dielectric material (preferably alumina) is applied on at least one surface. The dielectric material forms a reaction barrier between excess glass forced to the surface during firing and metallization positioned on the coating. The coating can be applied by screen printing, spraying a slurry of dielectric material, or spraying a slurry of dielectric material and an adhesive allowing low pressure lamination.

### FIELD OF THE INVENTION

This invention relates to laminated ceramic devices and more particularly to enhanced ceramic layers and methods of enhancing the ceramic layers.

### BACKGROUND OF THE INVENTION

At the present time, and especially in the RF field, many electronic components are formed on or in ceramic modules. In the process of forming the ceramic modules, thin sheets of unfired or “green” ceramic material are provided which, as is known in the art, usually includes Al₂O₃ particles, glass particles, and a binder, generally including organic material. Each sheet generally includes a plurality of module layers formed adjacent each other so as to share sides. Each module layer on the sheet generally includes some electrical traces and may further include some electrical components such as capacitors, inductors, resistors, etc. The electrical traces and electrical components are generally referred to herein as “metalization”. Each module layer also includes vias extending therethrough. Components and electrical traces may be formed on the sheets by screening (or the like) silver paste or other conductive material.

A plurality of the sheets (e.g., sometimes as many as fifty) are stacked or positioned in overlying relationship and vertically aligned to form common module sides through the entire stack. It will of course be understood that internal vias and various other connections are also aligned during this process to provide one or more complete interconnected circuits in each of the modules.

After the stacking and alignment of the sheets is accomplished, the stack is pressed under a uniaxial or isostatic pressure at an elevated temperature to produce bonding between adjacent sheets. As understood by those skilled in the art, the pressure and temperature must be sufficient to produce some bonding between the binders of adjacent sheets. If adequate binding does not occur, the sheets may be inadvertently separated during subsequent handling, resulting in destruction of the entire assembly.

Once the stack of unfired or green ceramic sheets has been assembled and the individual sheets bonded together, the stack is cut or otherwise divided into individual modules. Generally, for example, the stack is cut with a very sharp instrument. The cutting is easily accomplished since the sheets are still formed of unfired or green ceramic. Again, if the stack is not adequately bonded, the sheets may be inadvertently separated during the cutting operation.

One major problem that occurs is the migration to the surface of excess glass during the firing process. This excess glass reacts with the metalization to cause serious electrical problems in the finished product. As a specific example, when a resistor is formed on an unfired or green ceramic sheet, the excess glass can react with the terminals and/or resistive material to substantially change the resistance.

Accordingly it is highly desirable to provide new and improved unfired or green ceramic sheets in which the excess glass will not react with metalization and the like either on the surface or buried.

### BRIEF DESCRIPTION OF THE DRAWINGS

Referring to the drawings:

FIG. 1 is a simplified sectional view of a green or unfired ceramic layer with metalization thereon, illustrating the migration of excess glass;

FIG. 2 is a simplified sectional view illustrating a layer of green or unfired ceramic material with a dielectric coating in accordance with the present invention; and

FIG. 3 is a simplified view illustrating a method of applying the dielectric coating, in accordance with the present invention.

### DESCRIPTION OF THE PREFERRED EMBODIMENT

Generally, laminated ceramic devices are formed using a plurality of the sheets (sometimes as many as fifty), which are stacked or positioned in overlying relationship. As understood in the art, the sheets are formed of unfired or green ceramic material which usually includes Al₂O₃ particles, glass particles, and a binder, generally including organic material. The sheets may be cut from a continuous roll of tape, such as the T2000 tape manufactured by Heraeous under license by Motorola, INC. or Dupont's 951 tape.

A plurality of ceramic modules is produced during a single process, generally as described below. A plurality of module layers is defined on each sheet with each module layer on a sheet generally including some electrical traces, some electrical components such as capacitors, inductors, resistors, etc. During the stacking process, the sheets are vertically aligned to form common module sides through the entire stack (i.e. each module layer in a sheet overlies mating module layers in lower sheets). After the stacking and alignment of the sheets is accomplished, the stack is pressed under a uniaxial or isostatic pressure at an elevated temperature to produce bonding between adjacent sheets. As understood by those skilled in the art, the pressure and temperature must be sufficient to produce some bonding between the binders of adjacent sheets.

Once the stack of unfired or green ceramic sheets has been bonded together, the stack is cut or otherwise divided into individual modules. Generally, the green ceramic material includes Al₂O₃ particles, glass particles and an organic binder. In this case, the glass particles in the green ceramic material dictate the firing or sintering temperature, since the viscosity of the glass particles decreases and flows sufficiently to bind the aluminum particles together at a temperature of approximately 875° C. to leave a ceramic comprising Al₂O₃ particles bound together by at the least partially melted and reformed glass.

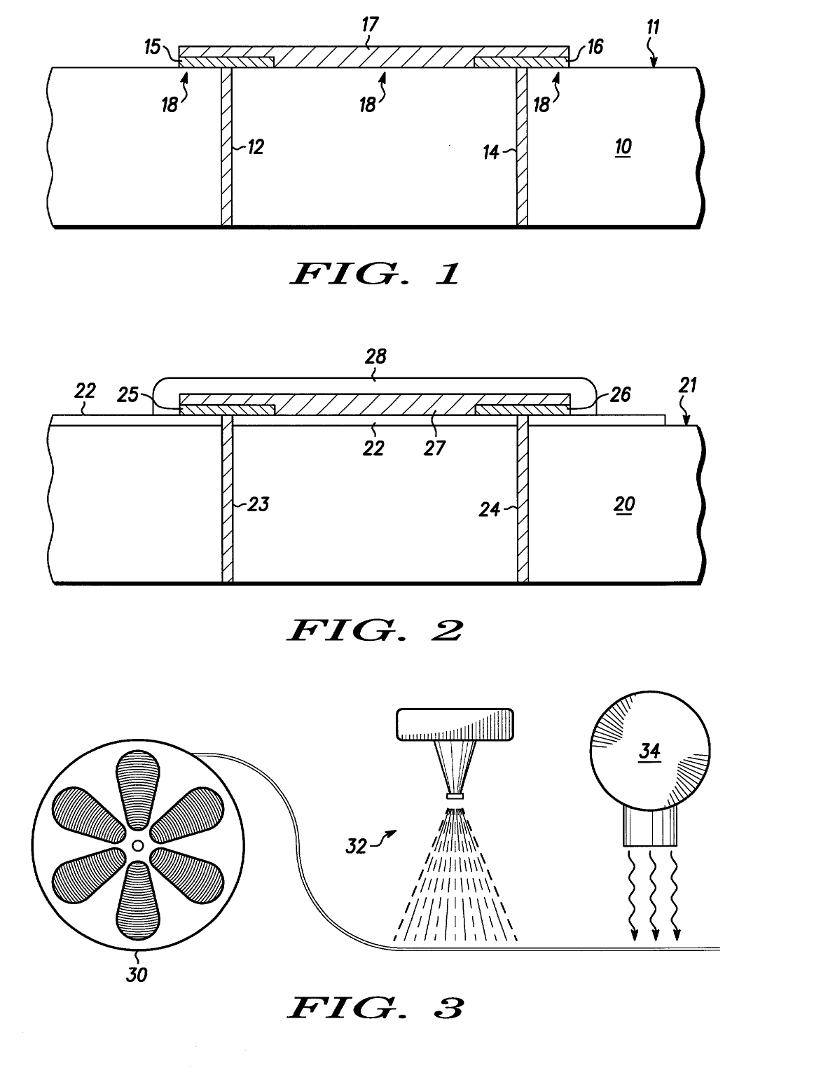

Referring specifically to FIG. 1, a layer 10 of unfired ceramic material is illustrated with an upper surface 11. Layer 10 can be, for example, a single sheet, a cross-section of a continuous tape, a plurality of sheets forming a final ceramic device, etc. A pair of vias 12 and 14, extending through sheet 10, are filled with a conductive material in a well known manner. A pair of spaced apart metallic terminals 15 and 16 are deposited on an upper surface 11 of sheet 10 and resistive material 17 is deposited between and in contact with terminals 15 and 16 to form a resistor. Here a resistor is described only for purposes of illustration and it will be understood that electrical traces, other electrical components, etc. are all subject to the same results. Throughout this description, electrical components and traces are referred to generally as “metalization” or “metalizations”.

As stated above, one major problem that occurs during firing or sintering of ceramic modules is the migration of excess glass. In the ceramic compositions utilized in laminated ceramic devices, the glass usually contains alkaline earth metals, such as calcium, strontium, barium, or the like. Generally, the glass is deficient in alumina. The alumina filler in the sheet or tape reacts with the glass to form an anorthite type phase, i.e., MO.Al₂O₃.2SiO₂, where M is one or more alkaline earth metals. Additional information on ceramic compositions can be found in U.S. Pat. No. 5,821,181, entitled “Ceramic Compositions”, issued Oct. 13, 1998, and incorporated herein by reference. Since the alumina in the ceramic sheet or tape is the limiting agent in the reaction, excess glass can diffuse into the metal conductors, resistors, inductors, etc. causing wetting problems in the metalization and/or changes in the properties of the metal components. During firing or sintering, the viscosity of the glass particles decreases and flows sufficiently to bind the aluminum particles together shile forcing some excess glass to the surfaces, as indicated generally by arrows 18. The glass reacts with the metalization, including terminals 15 and 16 and resistive material 17, and can substantially change the electrical and physical characteristics, including resistance and conductivity of traces, etc.

Turning now to FIG. 2, a simplified sectional view is illustrated of a layer 20 of green or unfired ceramic material with an upper surface 21. A dielectric coating 22 is applied to surface 21 in accordance with the present invention. A pair of spaced apart vias 23 and 24 are formed through sheet 20 and dielectric coating 22 and are filled with a conductive metalization. A pair of spaced apart metallic terminals 25 and 26 are deposited on dielectric coating 22 and resistive material 27 is deposited between and in contact with terminals 25 and 26 to form a resistor. Dielectric coating 22 forms a reaction barrier between excess glass forced to upper surface 21 during firing and metallic terminals 23 and 24 positioned on dielectric coating 22. An additional dielectric coating 28 may optionally be deposited over the metalization (e.g. resistive material 27) to form a reactive barrier to other sheets which may be laminated to sheet 20. Here it will be understood that an upper surface of layer 20 is described for convenience but other surfaces (e.g. including vias, lower surfaces and edges, etc.) which are intended to receive metalization can also have dielectric coating 22 applied thereto.

In a preferred embodiment, dielectric coating 22 includes alumina but it will be understood that other materials which perform the same function can be utilized. Because the glass particles in layer 20 of green or unfired ceramic material is designed to react with the Al₂O₃ particles, the excess glass in layer 20 reacts with the alumina in coating 22 to ultimately form a portion of the fired or sintered ceramic. Thus, during firing, the alumina in coating 22 forms a reaction barrier between excess glass forced to upper surface 21 and metallizations (e.g. terminals 25 and 26 and resistive material 27) positioned on coating 22. The alumina in the barrier layer (e.g. dielectric coating 22) reacts with the excess glass in sheet 20, preventing the diffusion of the glass into the metal conductors, resistors, inductors, etc.

Referring additionally to FIG. 3, a simplified view is illustrated representing a method of applying the dielectric coating (e.g. coating 22), in accordance with the present invention. Here a continuous tape 30 is illustrated, which may be, for example, the MOTOROLA T2000 tape. The surface designed to receive metalization, in this case the upper surface, is passed beneath a nozzle or nozzles 32 which spray a slurry containing alumina and water. The resulting coat of dielectric material is then passed beneath a dryer 34 to form the reaction barrier, which upon drying is ready for the metalization.

In another specific example, the dielectric coating is applied by screen printing. In this process a screen printable dielectric paste is provided by mixing 34.0 grams of alumina (e.g. Alcoa A16SG), 0.34 grams of Verquat CC42 (sold by Goldschmidt Chemical), 7.5 grams of solvent (e.g. Alpha Terpinal), and an organic screen print vehicle (e.g. ethyl cellulose dissolved in various solvents). Using the described screen printable dielectric paste, the dielectric coating can be screen printed on the surface of the tape, sheet, etc. (coatings 22 and 28), or generally in conjunction with the method in FIG. 3.

In yet another example, the dielectric coating and an adhesive allowing low pressure lamination can be combined and applied by spraying or the like. The adhesive for allowing low pressure lamination is described in detail in a copending U.S. patent application filed of even date herewith, entitled “Low-Pressure Laminated Ceramic Devices and Method”, bearing attorney docket number CT00-023, and incorporated herein by reference. In this process, each layer of green or unfired ceramic material has a coating on at least one surface which includes a dielectric forming the reaction barrier and the adhesive for allowing low pressure lamination.

Thus, metalization can be applied to the reaction barrier and is not affected by excess glass during the firing process. Also, features such as cavities and channels can be effectively incorporated into stacks of green ceramic sheets because such features are not deformed by the pressures required to produce the necessary bonding of the stack, also, the process is relatively inexpensive and easy to perform.

While we have shown and described specific embodiments of the present invention, further modifications and improvements will occur to those skilled in the art. We desire it to be understood, therefore, that this invention is not limited to the particular forms shown and we intend in the appended claims to cover all modifications that do not depart from the spirit and scope of this invention.

What is claimed is:

1. An enhanced ceramic layer for use in laminated ceramic devices comprising a layer of unfired ceramic material having a coating of dielectric material on at least a portion of one surface, the dielectric material forming a reaction barrier between excess glass forced to the at least a portion of one surface during firing and metallizations positioned on the coating of dielectric material.

2. An enhanced ceramic layer as claimed in claim 1 wherein the dielectric material includes alumina.

3. An enhanced ceramic layer as claimed in claim 1 wherein the layer of unfired ceramic material is a continuous roll of tape.

4. An enhanced ceramic layer for use in laminated ceramic devices comprising:
a layer of unfired ceramic material having a surface;
a coating of dielectric material positioned on the surface of the layer; and
metallization positioned on the coating of dielectric material, the coating of dielectric material forming a reaction barrier between excess glass and the metallization.

5. An enhanced ceramic layer as claimed in claim 4 wherein the dielectric material includes alumina.

6. An enhanced ceramic layer as claimed in claim 4 wherein the layer of unfired ceramic material is a continuous roll of tape.

7. A method of forming a barrier coating on an unfired ceramic layer comprising the steps of:
providing a layer of unfired ceramic material; and
forming a coating of dielectric material on at least one surface of the layer of unfired ceramic material, the dielectric material forming a reaction barrier between excess glass forced to the at least one surface during firing and metallizations positioned on the coating of dielectric material.

8. A method as claimed in claim 7 further including a step of forming a metalization on the coating of dielectric material.

9. A method as claimed in claim 7 wherein the step of forming the coating includes forming a coating including alumina.

10. A method as claimed in claim 7 wherein the step of forming the coating includes screen printing the coating on the at least one surface of the layer of unfired ceramic material.

11. A method as claimed in claim 10 wherein the step of screen printing includes a step of providing a solution including the dielectric material, a solvent, a dispersent, and an organic screen printing vehicle.

12. A method as claimed in claim 7 wherein the step of forming the coating includes applying, by one of spraying, curtain coating, and dipping, a slurry containing the dielectric material on the at least one surface of the layer of unfired ceramic material.

13. A method as claimed in claim 7 wherein the step of forming the coating includes applying, by one of spraying, curtain coating, and dipping, a slurry containing the dielectric material and a polymer adhesive on the at least one surface of the layer of unfired ceramic material.

14. A method as claimed in claim 13 wherein the step of applying by one of spraying, curtain coating, and dipping the slurry includes applying a slurry containing the dielectric material and a polymer interfacial material having a glass transition temperature such that it flows at a temperature below a temperature required for the layer of unfired ceramic material to substantially deform.
